(19) United States
(12) Patent Application Publication
(10) Pub. No.: US 2013/0143062 A1
(43) Pub. Date: Jun. 6, 2013

(54) METHOD AND SUPPORT MEMBER FOR MANUFACTURING WIRING SUBSTRATE, AND STRUCTURE MEMBER FOR WIRING SUBSTRATE

(71) Applicant: SHINKO ELECTRIC INDUSTRIES CO., LTD., Nagano (JP)

(72) Inventors: Kentaro KANEKO, Nagano (JP); Kazuhiro Kobayashi, Nagano (JP)

(73) Assignee: SHINKO ELECTRIC INDUSTRIES CO., LTD., Nagano (JP)

(21) Appl. No.: 13/691,931

(22) Filed: Dec. 3, 2012

(30) Foreign Application Priority Data
Dec. 6, 2011 (JP) 2011-266721

(51) Int. Cl. B32B 38/10; B32B 15/04; B32B 3/02

(52) U.S. Cl. CPC B32B 38/10; B32B 3/02; B32B 15/04
USPC 428/614; 428/77; 156/247

(57) ABSTRACT

A wiring substrate manufacturing method includes forming a layered configuration including a first metal layer, a peeling layer, and a second metal layer, removing an edge part of the layered configuration, so that the first metal layer is smaller than the second metal layer from a plan view, forming a support body by adhering the first metal layer to a base member and adhering the base member to a process part, the process part being formed by the removing of the edge part, forming a wiring substrate on the second metal layer, removing a part of the support body and a part of the wiring substrate that are superposed with respect to the process part from a plan view, and separating the second metal layer and the wiring substrate from the support body after the removing of the parts of the support body and the wiring substrate.

### CROSS-REFERENCE TO RELATED APPLICATIONS

This application is based upon and claims the benefit of priority of the prior Japanese Patent Application No. 2011-266721 filed on Dec. 6, 2011, the entire contents of which are incorporated herein by reference.

### FIELD

The embodiments discussed herein are related to a method and a support member for manufacturing a wiring substrate, and a structure member for the wiring substrate.

### BACKGROUND

As one known conventional method for manufacturing a wiring substrate, there is a method of adhering a metal foil to prepreg. With this method, first, a base layer is arranged on a target wiring formation area of the prepreg, then the metal foil is arranged on the prepreg interposed by the base layer, so that the metal foil having a larger area than the base layer contacts an outer peripheral part of the target wiring formation area, and then the prepreg is cured by applying heat and pressure thereto.
Patent Document 1: Japanese Laid-Open Patent Publication No.: 2007-158174

However, because a base layer is used in the conventional method for manufacturing the wiring substrate, manufacturing cost of the wiring substrate becomes high. For example, a copper foil is used as the base layer.

### SUMMARY

According to an aspect of the invention, there is provided a method for manufacturing a wiring substrate, the method including: forming a layered configuration including a first metal layer, a peeling layer, and a second metal layer; removing an edge part of the layered configuration, so that the first metal layer is smaller than the second metal layer from a plan view; forming a support body by adhering the first metal layer to a base member and adhering the base member to a process part, the process part being formed by the removing of the edge part of the layered configuration; forming a wiring substrate on the second metal layer; removing a part of the support body and a part of the wiring substrate that are superposed with respect to the process part from a plan view; separating the second metal layer and the wiring substrate from the support body after the removing of the part of the support body and the part of the wiring substrate.

The object and advantages of the invention will be realized and attained by means of the elements and combinations particularly pointed out in the claims.

It is to be understood that both the foregoing generation description and the followed detailed description are exemplary and explanatory and are not restrictive of the invention as claimed.

### BRIEF DESCRIPTION OF DRAWINGS

FIGS. 1A-1C are schematic diagrams illustrating steps for processing a layered body by using a method for manufacturing a wiring substrate (wiring substrate manufacturing method) according to the first embodiment of the present invention;

FIGS. 2A-2C are schematic diagrams illustrating the steps for manufacturing a support body with the wiring substrate manufacturing method according to the first embodiment of the present invention;

FIGS. 3A to 3C are schematic diagrams illustrating the steps for forming pads of a built-up substrate according to a wiring substrate manufacturing method of the first embodiment of the present invention;

FIGS. 4A to 4D are schematic diagrams illustrating a step for forming, for example, an insulating layer of a built-up substrate according to a wiring substrate manufacturing method of the first embodiment of the present invention;

FIGS. 5A-5D are schematic diagrams illustrating a step for forming a solder resist layer of a built-up substrate and a step for separating a structural body by using a wiring substrate manufacturing method according to the first embodiment of the present invention;

FIG. 6 is a cross-sectional view illustrating a built-up substrate manufactured by using a wiring substrate manufacturing method according to the first embodiment of the present invention;

FIG. 7 is a schematic diagram illustrating a step included in a wiring substrate manufacturing method according to a modified example of the first embodiment of the present invention;

FIGS. 8A and 8B are schematic diagrams illustrating the steps included in a wiring substrate manufacturing method according to another modified example of the first embodiment of the present invention;

FIGS. 9A and 9B are cross-sectional views illustrating a semiconductor package that includes a built-up substrate having a semiconductor chip mounted thereon;

FIGS. 10A-10C are schematic diagrams illustrating the steps included in the wiring substrate manufacturing method according to another modified example of the first embodiment of the present invention;

FIGS. 11A-11C are schematic diagrams illustrating steps included in a wiring substrate manufacturing method according to another modified example of the first embodiment of the present invention;

FIGS. 12A-12C are schematic diagrams illustrating steps for processing a layered body by using a method for manufacturing a wiring substrate (wiring substrate manufacturing method) according to the second embodiment of the present invention; and

FIGS. 13A-13B are schematic diagrams illustrating the steps for manufacturing a support body with the wiring substrate manufacturing method according to the second embodiment of the present invention.

### DESCRIPTION OF EMBODIMENTS

In the following, embodiments of a method and a support member for manufacturing a wiring substrate, and a structure member for the wiring substrate are described with reference to the accompanying drawings.

### First Embodiment

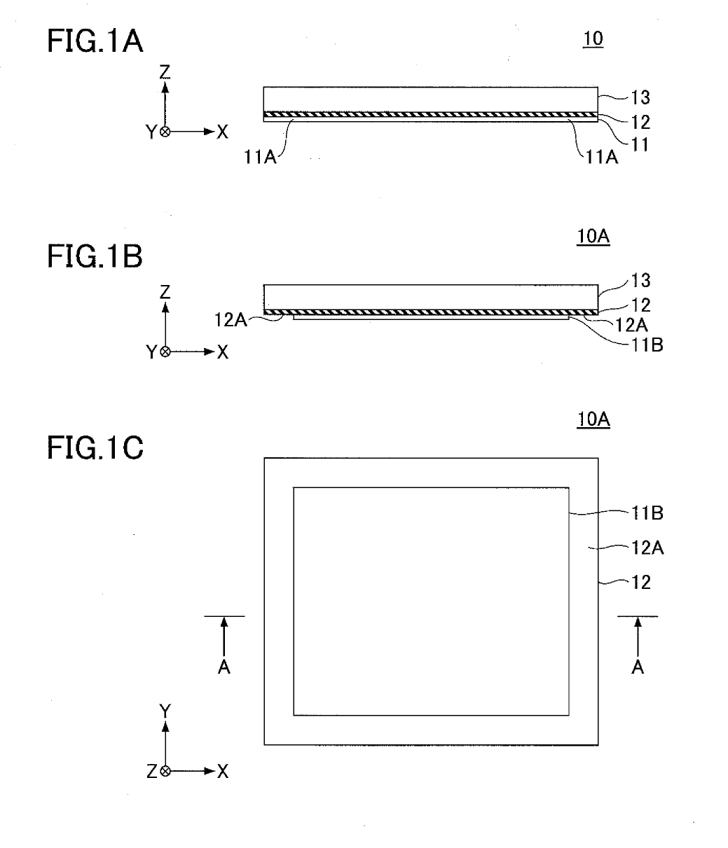

FIGS. 1A-1C are schematic diagrams illustrating steps for processing a layered body (layered configuration) by using a method for manufacturing a wiring substrate (wiring substrate manufacturing method) according to the first embodiment of the present invention. In this embodiment, XYZ coordinates are defined as illustrated in FIGS. 1A-1C.

With the wiring substrate manufacturing method according to the first embodiment, a layered body 10 having a cross-section illustrated in FIG. 1A is prepared. The layered body 10 has a layered structure including a metal foil 11, a peeling layer 12, and a metal foil 13 that are layered in this order.

The metal foil 11, the peeling layer 12, and the metal foil 13 have rectangular shapes of the same dimensions from a plan view (i.e. same dimensions with respect to the X axis direction and the Y axis direction). The dimensions of the metal foil 11, the peeling layer 12, and the metal foil 13 can be arbitrarily set in correspondence with the dimensions of the below-described wiring substrate.

The cross section illustrated in FIG. 1A is a cross section obtained by cutting the layered body 10 along an XZ plane at substantially the center of the layered body 10 from a plan view. The cross section illustrated in FIG. 1B is a cross section obtained by cutting the layered body 10 along line A-A of FIG. 1C.

The metal foil 11 is an example of a first metal layer. The metal foil 11 may be, for example, a copper foil. The thickness of the metal foil 11 (thickness in the Z axis direction) may be, for example, approximately 3 μm to 5 μm.

The peeling layer 12 is an example of a peeling layer interposed between the metal foil 11 and the metal foil 13. The peeling layer may be a metal layer (e.g., nickel (Ni) layer, chrome (Cr) layer, an inorganic layer (e.g., a layer formed of silicone oil), or a resin layer formed of an organic material (e.g., imidazole, triazole, or a silane coupling agent). The peeling layer 12 is used for adhering the metal foil 11 and the metal foil 13 together to build the layered body 10. In addition, the peeling layer 12 is used for separating the metal foil 11 in a subsequent step. Therefore, the peeling layer 12 is desired to have an adhesive property strong enough for building the layered body 10 but also an adhesive strength weak enough for allowing the metal foil 11 to be peeled therefrom. Accordingly, the adhesive strength between the metal foil 11 and the peeling layer 12 is set to be less than the adhesive strength between the metal foil 13 and the peeling layer 12.

The metal foil 13 is an example of a second metal layer. The metal foil 13 may be, for example, a copper foil. The thickness of the metal foil 13 (thickness in the Z axis direction) may be, for example, approximately 10 μm to 15 μm. In this embodiment, although the thickness of the metal foil 13 is greater than the thickness of the metal foil 11, the thickness of the metal foil 13 may be less than or equal to the thickness of the metal foil 11.

It is to be noted that a process for improving the adhesiveness between the peeling layer 12 and the metal foil 13 may be performed on the surface of the metal foil 13 to which the peeling layer 12 is adhered. The process for improving the adhesiveness may be, for example, a process of roughening a target surface (roughening process), a process of applying a silane coupling agent on a target surface (silane coupling process), or a process of applying a primer to a target surface (priming process). These processes are particularly effective in a case where the peeling layer 12 is a resin layer formed of an organic material.

A commercially available material having the metal foil 11, the peeling layer 12, and the metal foil 13 layered in the above-described manner may be used the layered body 10.

After preparing the above-described layered body 10, an edge part 11A extending along the four sides of the metal foil 11 of the layered body 10 illustrated in FIG. 1A is removed from the metal foil 11. The step of removing the edge part 11A is an example of a first step. The edge part 11A is a part of the metal foil 11 having a predetermined width with respect to each of the four sides of the metal foil 11. That is, the edge part 11A is a rectangular annular shaped part formed throughout the outer periphery of the metal foil 11.

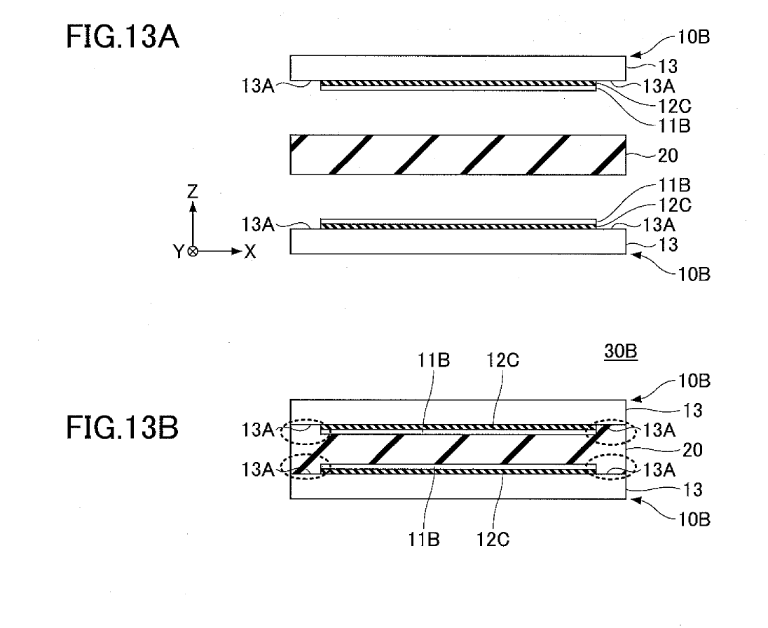

As a result of removing the edge part 11A, the layered body 10 illustrated in FIG. 1A becomes a layered body 10A illustrated in FIGS. 13 and 1C. That is, as illustrated in FIGS. 1B and 1C, the metal foil 11 of the layered body 10 of FIG. 1A is processed to become a metal foil 11B having a smaller outer periphery than the outer periphery of the peeling layer 12 and the outer periphery of the metal foil 13 from a plan view. The metal foil 11B of FIGS. 1B and 1C is a remaining part of the metal foil 11 of FIG. 1A from which the edge part 11A is removed.

A part of the peeling layer 12, which is positioned more outward than the metal foil 11B from a plan view, is hereinafter referred to as an outer edge part 12A of the peeling layer 12. As illustrated in FIG. 1C, the outer edge part 12A has a predetermined width with respect to each of the four sides of the peeling layer 12. The width of the outer edge part 12A may be, for example, approximately 1 mm to 100 mm. That is, the outer edge part 12A is part of the peeling layer 12 that becomes exposed by removing the edge part 11A from the metal foil 11 of FIG. 1A. The outer edge part 12A is an example of a process part of the layered body 10A.

The removing of the edge part 11A may be performed by, for example, forming a cut line between a border between the edge part 11A and the metal foil 11B by using a die, and peeling the edge part 11A from the metal foil 11. Alternatively, the removing of the edge part 11A may be performed by forming a cut line between a border between the edge part 11A and the metal foil 11B by using a laser (half cut), and peeling the edge part 11A from the metal foil 11. Alternatively, the removing of the edge part 11A may be performed by forming a mask on the surface of the metal foil 11 and removing the edge part 11A from the metal foil 11 by wet etching. Other methods besides those described above may also be used for removing the edge part 11A.

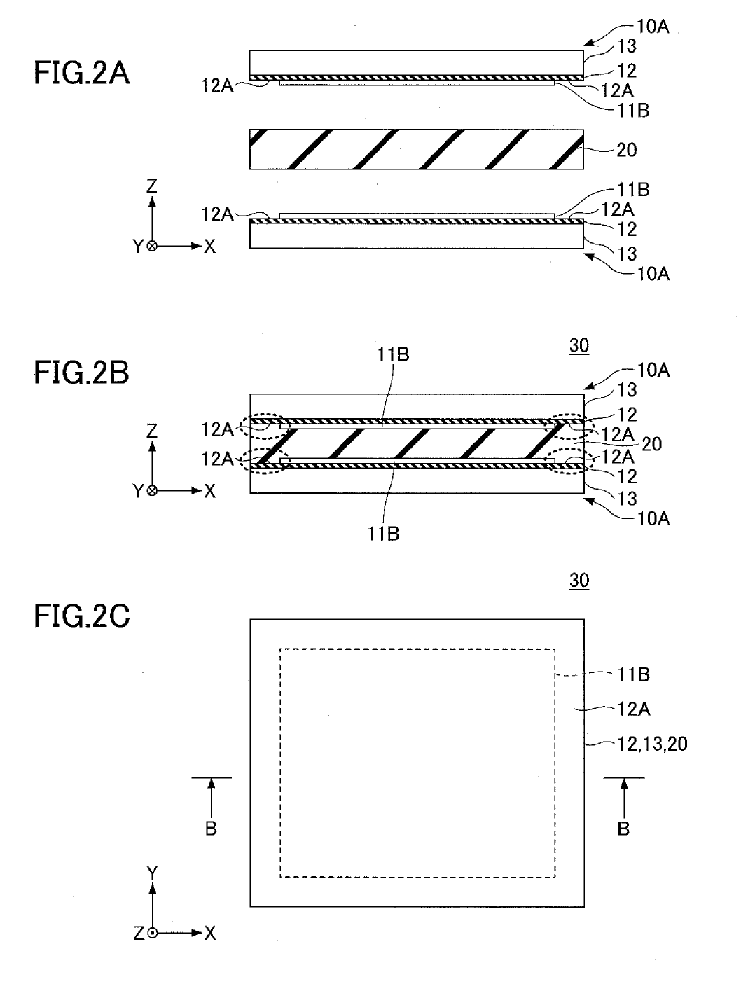

Next, the steps for manufacturing a support body 30 for manufacturing a wiring substrate according to an embodiment of the present invention is described with reference to FIGS. 2A-2C. In this embodiment, the support body 30 is manufactured by adhering the layered body 10A to prepreg 20.

FIGS. 2A-2C are schematic diagrams illustrating the steps for manufacturing a support body 30 with the wiring substrate manufacturing method according to the first embodiment of the present invention. The XYZ coordinates used in FIGS. 1A-1C apply to the XYZ coordinates of FIGS. 2A-2C. FIGS. 2A and 2B are cross-sectional views illustrating a part of the steps for manufacturing the support body 30. FIG. 2C is a plan view illustrating a part of the steps for manufacturing the support body 30. FIG. 2B is a cross-sectional view taken along line B-B of FIG. 2C. FIG. 2A is a cross-sectional view corresponding to FIG. 2B.

In the steps illustrated in FIGS. 2A-2C, the prepreg 20 is used. The prepreg 20 is an example of an adhesive layer. For example, a semi-cured material (i.e. a material in a so-called B-stage) may be used as the prepreg 20. For example, the prepreg 20 may be a woven fabric (e.g., woven glass fabric, woven carbon fabric) or a non-woven fabric (e.g., non-woven glass fabric, non-woven carbon fabric) that is impregnated in an insulating resin (e.g., epoxy resin, polyimide resin). It is preferable to use a thermosetting resin as the insulating resin.

As long as the prepreg 20 can maintain a sufficient heat releasing property and strength, a filler may be mixed into the insulating resin of the prepreg 20 or an insulating resin containing no fiber may be used as the prepreg 20. For example, alumina or silica may be used as the filler mixed into the insulating resin of the prepreg 20.

In the first embodiment, the dimensions of the prepreg 20 from a plan view (i.e. dimensions in the X axis direction and the Y axis direction) are the same as the dimensions of the peeling layer 12 and the metal foil 13 of the layered body 10A. Further, the thickness of the prepreg 20 (thickness in the Z axis direction) may be, for example, approximately 200 μm to 1000 μm.

First, as illustrated in FIG. 2A, two layered bodies 10A and the prepreg 20 are prepared. The positions of the two layered bodies 10A and the prepreg 20 are to be matched among each other. That is, the metal foil 11B of the layered body 10A on the upper side (i.e. the side toward positive side of the Z axis direction) of the prepreg 20 is facing downward, and the positions of the peeling layer 12 and the metal foil 13 of the layered body 10A are matched with the position of the prepreg 20. Likewise, the metal foil 11B of the layered body 10A on the lower side (i.e. the side toward the positive side of the Z axis direction) of the prepreg 20 is facing upward, and the positions of the peeling layer 12 and the metal foil 13 are matched with the position of the prepreg 20.

Then, the prepreg 20 is cured by applying heat and pressure to the prepreg 20 in a state where the prepreg 20 is sandwiched between the two layered bodies 10A. Thereby, the two layered bodies 10A are respectively adhered to the upper and lower sides of the prepreg 20. In this embodiment, a vacuum laminator is used to cure the prepreg 20. This step of curing the prepreg 20 is an example of a second step.

In adhering each of the layered bodies 10A to the prepreg 20 as illustrated in FIGS. 2B and 2C, the metal foil 11B and the prepreg 20 are adhered to each other at a center part of the layered body 10A from a plan view. The outer edge part 12A of the peeling layer 12 is adhered to a portion of the prepreg 20 that is located further outward than the metal foil 11B from a plan view. The areas indicated with broken lines in FIG. 2B correspond to the areas at which the outer edge part 12A and the portion of the prepreg 20 are adhered to each other.

By adhering the two layered bodies 10A to the prepreg 20 together, the manufacturing of the support body 30 is completed as illustrated in FIGS. 2B and 2C. Thus, the support body 30 is a member that has two layered bodies 10A adhered to the upper and lower sides of the prepreg 20, respectively. The support body 30 has rigidity that is strong enough to support the below-described built-up substrate 53 during the subsequent steps of forming the built-up substrate 53 on the metal foil 13 of the layered body 10A.

The support body 30 of the first embodiment has the metal foil 11B and the outer edge part 12A of the peeling layer 12 adhered to the prepreg 20. The adhesive strength between metal foil 11B and the prepreg 20 is greater than the adhesive strength between the metal foil 11B and the peeling layer 12.

In this embodiment, the adhesive strength between the metal foil 11B and the peeling layer 12 is set to be significantly weak compared to the adhesive strength between the metal foil 11B and the prepreg 20 because the metal foil 11B is to be peeled from the peeling layer 12 in a subsequent step.

Therefore, in the state illustrated in FIG. 2B, the layered body 10A and the prepreg 20 are adhered mainly by the adhesive strength between the outer edge part 12A and the prepreg 20.

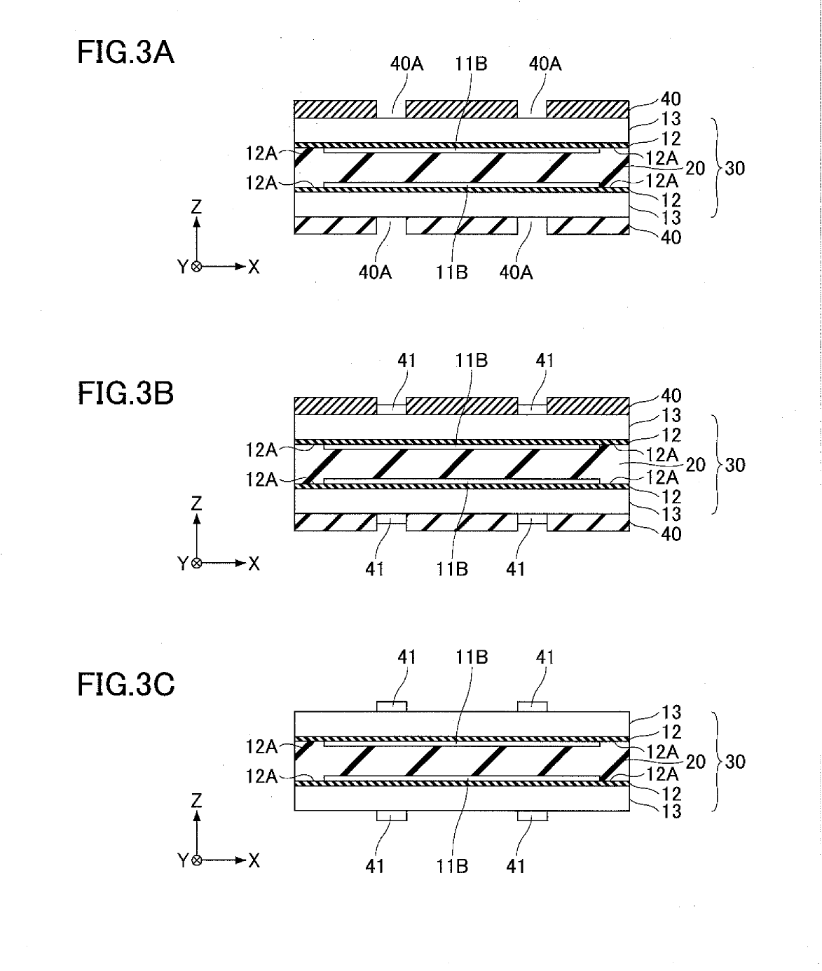

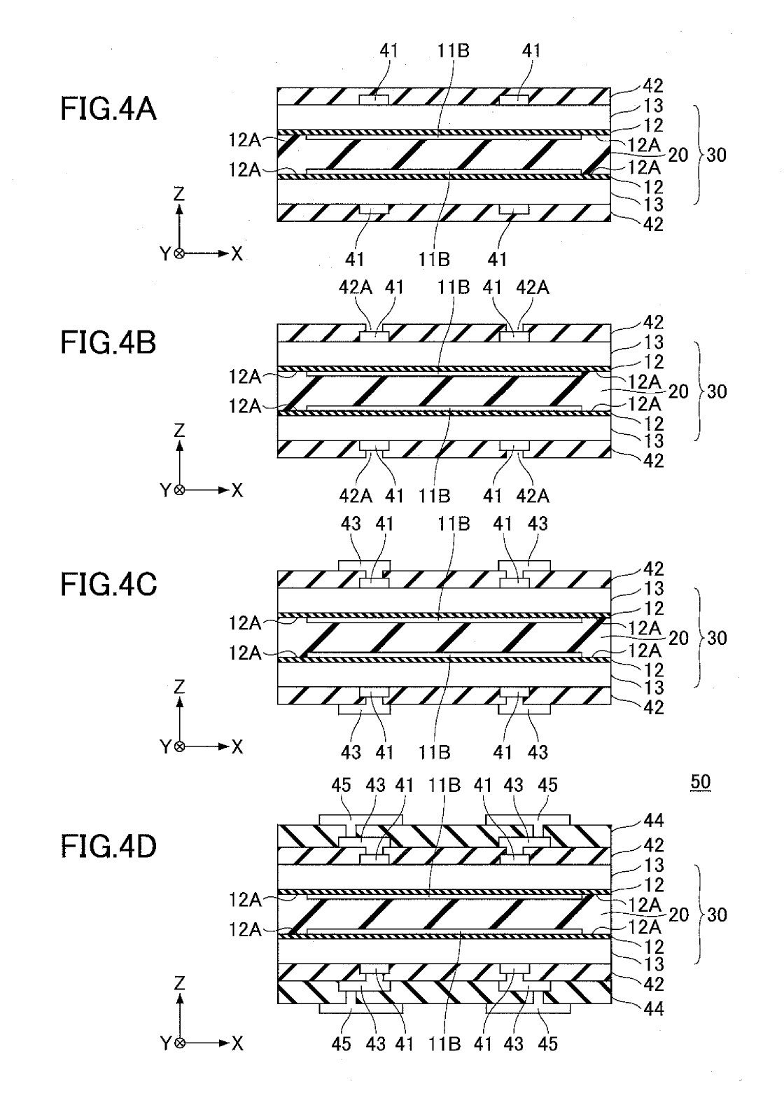

Next, the steps of forming a built-up substrate 53 are described with reference to FIGS. 3A to 4D.

First, the steps for forming pads 41 of the built-up substrate 53 on a surface of the metal foil 13 are described with reference to FIGS. 3A to 3C.

FIGS. 3A to 3C are schematic diagrams illustrating the steps for forming the pads 41 of the built-up substrate 53 according to a wiring substrate manufacturing method according to the first embodiment of the present invention. The XYZ coordinates used in FIGS. 1A-1C apply to the XYZ coordinates of FIGS. 3A-3C. The cross-sections illustrated in FIGS. 3A-3C include the cross-sections illustrated in FIGS. 1A-1B and FIGS. 2A-2B.

First, as illustrated in FIG. 3A, a plating resist 40 is formed on a surface of each of the two metal foils 13 of the support body 30. The plating resist 40 is patterned, so that opening parts 40A are formed in a predetermined area at which the pads 41 are to be formed.

Then, as illustrate in FIG. 3B, the pads 41 are formed by performing an electroplating process on the support body 30. In the case of performing the electroplating process, the two metal foils 13 are used as power feeding layers to which voltage is applied. The pad 41 is an example of a wiring layer of a wiring substrate. The pad 41 may be formed of, for example, gold (Au) or copper (Cu). The pad 41 may have a layered configuration including multiple metal layers. For example, the pad 41 may be a gold/palladium/nickel/copper (Au/Pd/Ni/Cu) layer ((i.e. a layered configuration including a Au layer, a Pd layer, a Ni layer, and a Cu layer that are layered in this order).

Then, as illustrated in FIG. 3C, a configuration having the pads 41 arranged in predetermined areas of the surface of the metal foil 13 of the support body 30 is obtained by removing the plating resist 40.

Next, the steps for forming, for example, an insulating layer 42 of the built-up substrate 53 are described with reference to FIGS. 4A-4D. FIGS. 4A to 4D are schematic diagrams illustrating a step for forming, for example, the insulating layer 42 of the built-up substrate 53 according to a wiring substrate manufacturing method of the first embodiment of the present invention. The XYZ coordinates used in FIGS. 1A-1C apply to the XYZ coordinates of FIGS. 3A-3C. The cross-sections illustrated in FIGS. 4A-4D include the cross-sections illustrated in FIGS. 1A-1B, FIGS. 2A-2B, and FIGS. 3A-3C.

First, as illustrated in FIG. 4A, the insulating layer 42 is formed covering the two metal foils 13 and the pads 41 formed on the surfaces of the metal foils 13. The insulating layer 42 may be formed of, for example, an epoxy resin or a polyimide resin. The insulating layer 42 is an example of an insulating layer included in the built-up substrate.

The insulating layer 42 may be formed by forming a film-like epoxy resin or a polyimide resin into a semi-cured resin film, laminating the semi-cured resin film, and curing the semi-cured film by applying heat and pressure with a vacuum laminator.

Then, as illustrated in FIG. 4B, via holes 42A are formed in the insulating layers 42. The via hole 42A may be formed by using, for example, a laser processing method. The via hole 42A is shaped as an opening part formed on the surface of the insulating layer 42. The pad 41 serves as a bottom surface of the via hole 42A. The via hole 42A has a circular truncated cone cross section in which the diameter toward the opening of the via hole 42A is larger than the diameter of the bottom of the via hole 42A.

Then, as illustrated in FIG. 4C, a wiring layer 43 is formed inside of the via hole 42A and on the insulating layer 42. The wiring layer 43 is connected to the pad 41 by way of the via hole 42A. The wiring layer 43 may be formed by using, for example, a semi-additive method. The wiring layer 43 is an example of a wiring layer included in the built-up substrate.

An example of forming the wiring layer 43 with the semi-additive method is described below. First, a seed layer is formed on an inner wall and a bottom surface of the via hole 42A and a surface of the insulating layer 42 by performing an electroless copper plating method or a copper-sputtering method. Then, a plating resist pattern is formed on the seed layer. The plating resist pattern includes an opening part(s) that constitutes a shape of a wiring pattern. Then, a copper plating (which is to become the wiring pattern) is deposited on the seed layer exposed in the opening part and the inner wall of the via hole 42A by performing a copper electroplating method where the seed layer is used as the power feeding layer. Then, the plating resist is removed. Then, the seed layer exposed from the wiring pattern is removed. Thereby, the forming of the wiring layer 43 is completed.

Then, by repeating the steps described with FIGS. 4A-4C, an insulating layer 44 and a wiring layer 45 are formed. The wiring layer 45 is connected to the wiring layer 43 by way of the via hole formed in the insulating layer 44.

By performing the above-described steps, a structural body (also referred to as “structure member”) 50 illustrated in FIG. 4D is formed. The steps illustrated in FIGS. 4A-4D are examples of a third step for forming the built-up substrate.

Next, a step for forming a solder resist layer of the built-up substrate and a step for separating the structural body 50 are described.

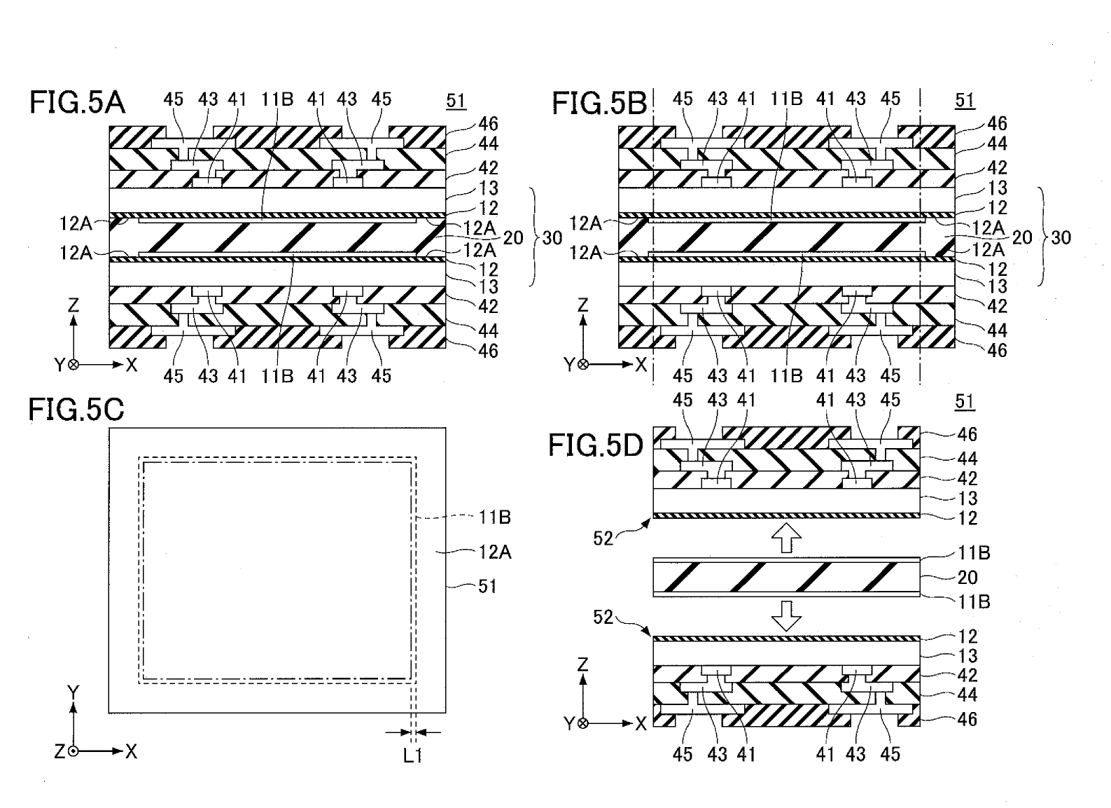

FIGS. 5A-5D are schematic diagrams illustrating a step for forming a solder resist layer 46 of the built-up substrate 53 and a step for separating the structural body 50 by using the wiring substrate manufacturing method according to the first embodiment of the present invention. The XYZ coordinates used in FIGS. 1A-1C apply to the XYZ coordinates of FIGS. 5A-5D. The cross-sections illustrated in FIGS. 5A, 5B, and 5D include the cross-sections illustrated in FIGS. 1A-1B, FIGS. 2A-2B, and FIGS. 3A-3C.

First, as illustrated in FIG. 5A, the solder resist layers 46 are formed on the structural body 50 obtained in the step illustrated in FIG. 4D. The solder resist layers 46 are formed by applying a photosensitive solder resist resin on the upper and lower surfaces of the structural body 50 and exposing the applied photosensitive solder resist resin with a negative film. Thereby, the solder resist layer 46 having a desired pattern remains on the surface of the structural body 50. The solder resist layer 46 is patterned, so that an opening part exposing a part of the wiring layer 45 is formed in the solder resist layer 46. The part of the wiring layer 45 exposed from the opening part of the solder resist layer 46 is a pad.

Thereby, a structural body 51 illustrated in FIG. 5A is obtained. The structural body 51 is an example of a structural body for a wiring substrate.

Then, the structural body 51 is cut along the dash-dot line illustrated in FIGS. 5B and 5C.

The broken line illustrated in FIG. 5C indicates the outline of the metal foil 11B of FIG. 5B from a plan view. The dash-dot line is depicted in a position that is a predetermined length L1 inward relative to an outer periphery of the metal foil 11B.

The structural body 51 may be cut by using, for example, a laser or a cutter. Alternatively, the structural body 51 may be cut by forming holes with, for example, a drill or a router. The step of cutting of the structural body 51 along the dash-dot line is an example of a fourth step.

Although it is preferable to cut the structural body 51 along the dash-dot line that is positioned more inward relative to the outer periphery of the metal foil 11B (illustrated with the broken line in FIG. 5C), the structural body 51 may be cut along the broken line as long as the adhering part between the outer edge part 12A and the prepreg 20 can be removed.

In the case where the structural body 51 is cut along the broken line, a part of the structural body 51, which superposes the outer edge part (process part) 12A from a plan view (i.e. a part positioned more outward relative to the broken line in FIG. 5C), is removed. The superposed part of the structural body 51 positioned more outward relative to the broken line is an example of a superposed part.

In the case of cutting the structural body 51 along the dash-dot line, a part of the structural body 51 positioned a predetermined length (L1) inward than the outer edge part (process part) 12A from a plan view is removed.

Then, after the structural body 51 is cut in the steps illustrated in FIGS. 5B and 5C, the prepreg 20 together with the two metal foils 11B are separated from the two structural bodies 52 by peeling the peeling layers 12 from corresponding metal foils 11B as illustrated in FIG. 5D.

The structural body 52 includes, for example, the peeling layer 12, the metal foil 13, the pads 41, the insulating layers 42, the wiring layers 43, the insulating layer 44, the wiring layer 45, and the solder resist layer 46. The peeling layer 12 and the metal foil 13 act as a carrier of the structural body 52. Thus, the structural body 52 is configured having the built-up substrate 53 layered on the carrier including the peeling layer 12 and the metal foil 13. The built-up substrate 53 includes, for example, the pads 41, the insulating layers 42, the wiring layers 43, the insulating layers 44, the wiring layers 45, and the solder resist layer 46.

By performing the separating step illustrated in FIG. 5D, two structural bodies 52 (each one including the building substrate 53) can be obtained.

The prepreg 20 and the peeling layer 12 of the structural body 51 illustrated in FIG. 5A are adhered to each other mainly by the adhesive strength between the outer edge part 12A and the prepreg 20. This is because the adhesive strength between the metal foil 11B and the peeling layer 12 is set to be less than the adhesive strength between the outer edge part 12A and the prepreg 20. That is, the adhesive strength between the metal foil 11B and the peeling layer 12 is set with an adhesive strength that allows the metal foil 11B to be peeled from the peeling layer 12 during the separating step of FIG. 5D.

Accordingly, by cutting the structural body 51 along the dash-dot line illustrated in FIGS. 5B and 5C, the adhering part between the outer edge part 12A of the peeling layer 12 and the prepreg 20 is removed. Thereby, only the adhering part between the metal foil 11B and the prepreg 20 remains between the prepreg 20 and the structural body 52.

Therefore, in a case where a small amount of stress is applied to the structural body 51 after the structural body 51 is cut along the dash-dot line illustrated in FIGS. 5B and 5C, the metal foil 11B and the peeling layer 20 can be easily separated from each other as illustrated in FIG. 5D. The step illustrated in FIG. 5D is an example of a fifth step.

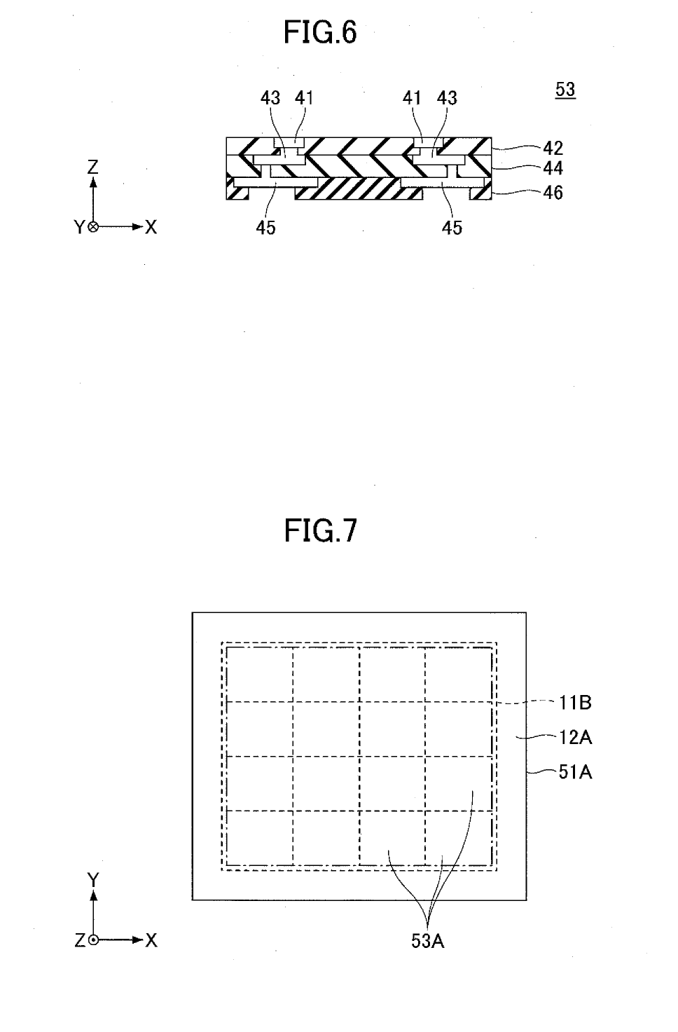

Next, the steps for removing the peeling layer 12 and the metal foil 13 from the structural body 52 is described with reference to FIG. 6.

FIG. 6 is a cross-sectional view illustrating the built-up substrate 53 manufactured by using the wiring substrate manufacturing method according to the first embodiment of the present invention. In FIG. 6, the XYZ coordinates used in FIG. 5D apply to the XYZ coordinates of FIG. 6. The cross-section illustrated in FIG. 6 include the cross-section illustrated in FIG. 5D.

The built-up substrate 53 illustrated in FIG. 6 includes, for example, the pads 41, the insulating layer 42, the wiring layer 43, the insulating layer 44, the wiring layer 45, and the solder resist layer 46. The built-up substrate 53 is an example of a wiring substrate manufactured by using the wiring substrate manufacturing method according to the first embodiment of the present invention.

The built-up substrate 53 is manufactured by removing the peeling layers 12 and the metal foils 13 from the structural bodies 52 illustrated in FIG. 5D. The removing of the peeling layers 12 and the metal foils 13 may be performed by, for example, a wet etching method.

Hence, with the above-described wiring substrate manufacturing method according to the first embodiment, in a state where the outer edge part 12A of the peeling layer 12 and the prepreg 20 is adhered to each other after the edge part 11A of the metal foil 11 has been removed, the wiring layer 43 and the like are formed to form the built-up substrate 53. Then, the adhering part between the outer edge part 12A and the prepreg 20 is cut off (see, for example, FIGS. 5B and 5C).

Then, the structural bodies 52 are separated from the prepreg 20 and the metal foils 11B. Then, by removing the peeling layers 12 and the metal foils 13 from the structural bodies 52, the built-up substrate is manufactured.

Hence, compared to a conventional wiring substrate manufacturing method, the built-up substrate 53 can be manufactured at a low cost because the wiring substrate manufacturing method can manufacture the built-up substrate 53 without using a base layer.

In a case where the conventional wiring substrate manufacturing method uses a base layer, foreign material may be interposed between the base layer and the metal foil when, for example, foreign material is adhered to the base layer. Accordingly, dents may be formed on the metal foil during a middle of a manufacturing process. The dents may cause deformation of a layered structure. As a result, the built-up substrate 53 (which is to be the final product) may also become deformed.

In contrast, the wiring substrate manufacturing method according to the first embodiment manufactures the built-up substrate 53 without using the base layer. Since the base layer is not used, the possibility of foreign material entering a layered structure of the built-up substrate 53 during a process of manufacturing a wiring substrate can be reduced.

Accordingly, reliability during a manufacturing process can be improved compared to the conventional wiring substrate manufacturing method using a base layer.

If the edge part 11A of the metal foil 11 (see, for example, FIG. 1A) is not removed, the structural body 51 (see, for example, FIG. 5A), the prepreg 20 and the wiring layer 43 of the structural body 51 (see, for example, FIG. 5A), would be adhered to each other only at the adhering part between the metal foil 11 and the peeling layer 12.

As described above, the adhesive strength between the metal foil 11 and the peeling layer 12 is set to a relatively small amount, so that the metal foil 11B can be peeled from the peeling layer 12. However, if the adhesive strength between the metal foil 11 and the peeling layer 12 is too weak, the metal foil 11 and the peeling layer 12 may unexpectedly peel from each other during a step of manufacturing the built-up substrate 53 and result to difficulty of forming, for example, the wiring layer 53 in a subsequent process.

If the adhesive strength between the metal foil 11 and the peeling layer 12 is too large (strong), it would become difficult to separate the metal foil 11 and the peeling layer 12 in the step illustrated in FIG. 5D.

Therefore, the setting of the adhering force of the peeling layer 12 is not easy, and various factors are to be considered when setting the adhering force of the peeling layer 12.

However, with the wiring substrate manufacturing method according to the first embodiment of the present invention, the edge part 11A of the metal foil 11 is removed, and the outer edge part 12A of the peeling layer 12 is adhered to the prepreg 20. Because the prepreg 20 and the outer edge part 12A are adhered to each other by applying heat and pressure to the prepreg 20, the outer edge part 12A of the peeling layer 12 and the prepreg 20 can be adhered to each other with a substantial amount of strength regardless of the adhesive strength of the peeling layer 12.

Then, after the structural body 51 is manufactured (see, for example, FIG. 5A), a part of the structural body 51 positioned more outward than the dash-dot line of FIGS. 5B and 5C is cut off. Then, the structural bodies 52 are separated from the metal foils 11B and the prepreg 20.

Accordingly, because the peeling layer 12 can attain an adhesive strength sufficient to adhere the peeling layer 12 and the metal foil 11B together, the adhesive strength of the peeling layer 12 can be set significantly easily compared to a case of not removing the edge part 11A of the metal foil 11.

Hence, with the wiring substrate manufacturing method according to the first embodiment of the present invention, the built-up substrate 53 can be manufactured significantly easily.

Although built-up substrates 53 are formed one on each side of the prepreg 20 (upper and lower sides of the prepreg 20) according to the above-described embodiment, a single built-up substrate 53 may be formed on either the upper side or the lower side of the prepreg 20.

Further, multiple built-up substrates 53 may be formed on each side of the prepreg 20 (upper and lower sides of the prepreg 20) as illustrated in FIG. 7.

FIG. 7 is a schematic diagram illustrating a step included in a wiring substrate manufacturing method according to a modified example of the first embodiment of the present invention. The step illustrated in FIG. 7 is a modified example of the step illustrated in FIG. 5C.

FIG. 7 illustrates a structural body 51A having regions 53A in which the built-up substrate 53 are manufactured. In FIG. 7, four regions 53A are arranged in the X axis direction, and four regions 53A are arranged in the Y axis direction.

Thus, the structural body 51A illustrated in FIG. 7 includes four structure units arranged in the X axis direction and four structure units arranged in the Y axis direction, in which each structure unit of the structural body 51A corresponds to the structure of the structural body 51 illustrated in FIG. 5A.

After the structural body 51A is manufactured, the structural body 51A is cut off along the dash-dot line illustrated in FIG. 7. Then, the metal foil 12 and the prepreg 20 are separated from the structural body 51A. Then, after the peeling layer 12 and the metal foil 13 are removed, the structural body 51A is separated into pieces in correspondence with the regions 53A (in this example, 16 regions 53A) of the structural body 51A.

By the step illustrated in FIG. 7, 16 built-up substrates 53 (see, for example, FIG. 6) can be obtained from each of the upper and lower sides of the prepreg 20 of the structural body 51A illustrated in FIG. 7. That is, a total of 32 built-up substrates 53 can be manufactured with a single structural body 51A. Hence, multiple built-up substrates 53 can be manufactured on each of the upper and lower sides of the prepreg 20.

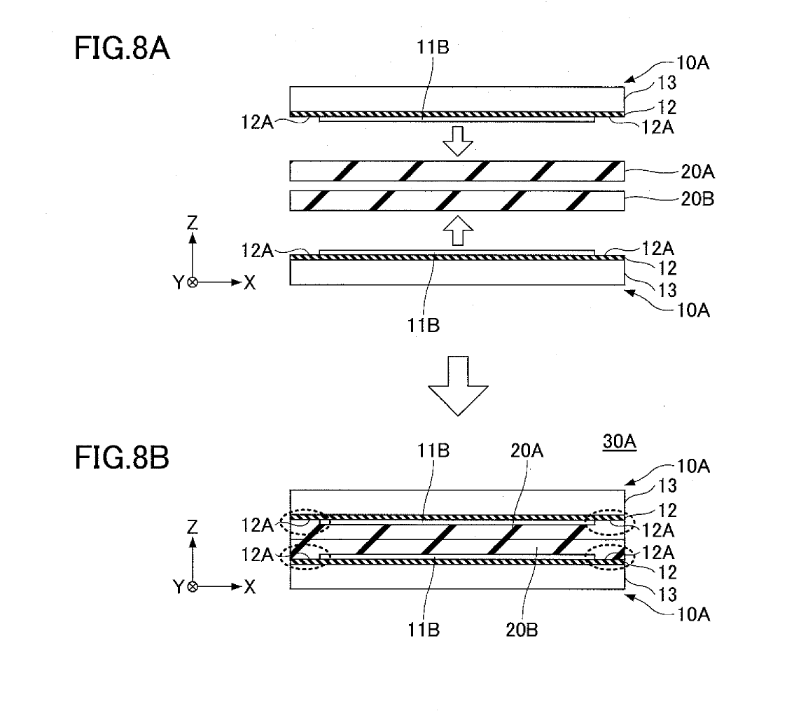

FIGS. 8A and 8B are schematic diagrams illustrating the steps included in a wiring substrate manufacturing method according to another modified example of the first embodiment of the present invention. The steps illustrated in FIGS. 8A and 8B are modified examples of the steps illustrated in FIGS. 2A and 2B, respectively.

As illustrated in FIG. 8A, two superposed prepregs 20A, 20B may be used. The prepregs 20A, 20B are the same as the prepreg 20 illustrated in FIGS. 2A and 2B. The areas indicated with broken lines in FIG. 8B correspond to the areas at which the outer edge part 12A and the portion of the prepreg 20A, 20B are adhered to each other.

By manufacturing a support body 30A by using the two prepregs 20A, 20B, rigidity of the support body 30A can be increased because the total thickness of the prepregs 20A, 20B increases compared to a case where the support body 30 is manufactured by using a single prepreg 20.

Therefore, the number of prepregs 20 can be adjusted in accordance with, for example, the weight of the built-up substrate 53 (weight of the final product) or the load applied to the support body 30 during the processes of manufacturing the built-up substrate 53. It is to be noted that 3 or more prepregs 20 may be used in manufacturing the support body 30.

The built-up substrate 53 manufactured by the wiring substrate manufacturing method according to the first embodiment of the present invention is a coreless type built-up substrate that can be manufactured without a so-called core material. One typical example of a core material is formed by impregnating a glass fabric material in an epoxy resin and adhering copper foil onto both sides of impregnated glass fabric material.

In a case where the core material is used in manufacturing a built-up substrate, the thickness of the built-up substrate increases in correspondence with the thickness of the glass fabric material. In addition, it becomes difficult to form, for example, via holes with a fine pitch in the case where the core material is used.

However, with the wiring substrate manufacturing method according to the first embodiment of the present invention, a coreless type built-up substrate 53 can be manufactured. Accordingly, the thickness of the built-up substrate 53 can be reduced, and via holes or the like can be formed with a fine pitch. Moreover, the built-up substrate 53 can be manufactured at a low cost owing to the built-up substrate 53 manufactured without a core material.

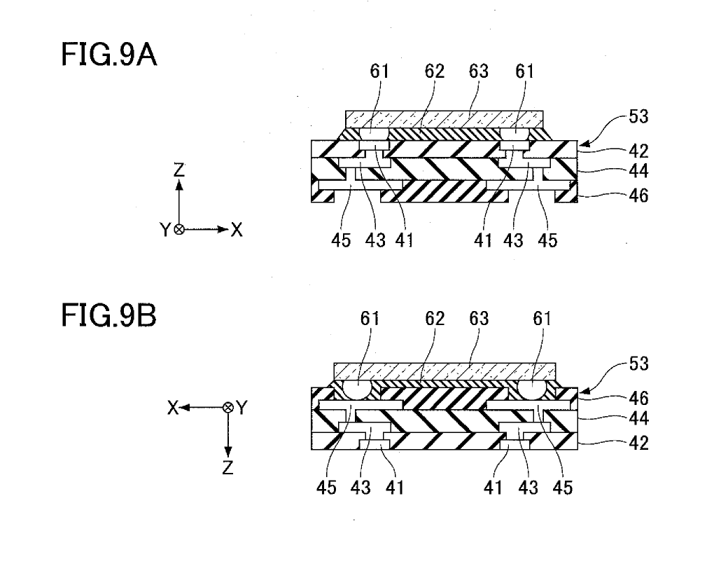

Next, an example of a semiconductor package including the built-up substrate 53 manufactured by the wiring substrate manufacturing method according to the first embodiment of the present invention is described with reference to FIGS. 9A and 9B. In this example, the semiconductor package has a semiconductor chip 63 mounted on the built-up substrate 53.

FIGS. 9A and 9B are cross-sectional views illustrating a semiconductor package that includes the built-up substrate 53 having the semiconductor chip 63 mounted thereon. The XYZ coordinates used in FIGS. 1A-1C apply to the XYZ coordinates of FIGS. 9A-9B. The cross-section illustrated in FIGS. 9A and 93 includes the same cross-section illustrated in FIG. 6.

FIG. 9A illustrates an example where a flip-chip bonding method is used in which bumps 61 are connected to corresponding pads 41, and the semiconductor chip 63 is mounted (hereinafter also referred to as “flip-chip mounted”) on the built-up substrate 53 by using an underfill resin 62.

FIG. 9B illustrates an example where a flip-chip bonding method is used in which the built-up substrate 53 is flipped vertically with respect to the built-up substrate 53 illustrated in FIG. 9A. In the state illustrated in FIG. 9B, the bumps 61 are connected to corresponding pads of the wiring layer 45, and the semiconductor chip is mounted on the built-up substrate 53 by using the underfill resin 62.

The bump 61 may be, for example, solder or a bump formed of gold (Au). The underfill resin 62 may be, for example, an epoxy resin. The semiconductor chip 63 may be, for example, a CPU (Central Processing Unit) chip constituted by a so-called LSI (Large Scale Integrated Circuit).

The mounting of the semiconductor chip 63 may be performed before the removing of the peeling layer 12 and the metal foil 13.

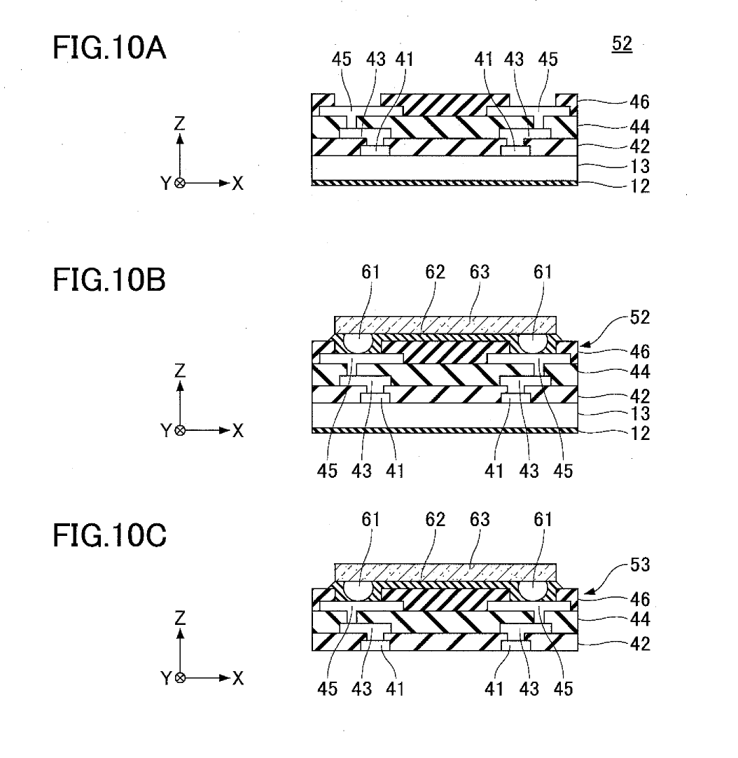

FIGS. 10A-10C are schematic diagrams illustrating the steps included in the wiring substrate manufacturing method according to another modified example of the first embodiment of the present invention. The steps illustrated in FIGS. 10A-10C are modified examples of the steps illustrated in FIG. 5D and FIG. 6. The XYZ coordinates applied to the structural body 52 on the upper side of the prepreg 20 in FIG. 5D apply to the XYZ coordinates of FIGS. 10A-10C.

FIG. 10A illustrates the structural body 52. The structural body 52 illustrated in FIG. 10A is a structural body 52 in a state before the peeling layer 12 and the metal foil 13 are peeled from the built-up substrate 53.

As illustrated in FIG. 102, a flip-chip bonding method may be used where the bumps 61 are connected to the wiring layer 45 of the structural body 52, and the semiconductor chip 63 may be flip-chip mounted on the built-up substrate 53 by using the underfill resin 62.

Then, as illustrated in FIG. 100, the built-up substrate 53 having the semiconductor chip 63 mounted thereon by flip-chip bonding is manufactured by removing the peeling layer 12 and the metal foil 13.

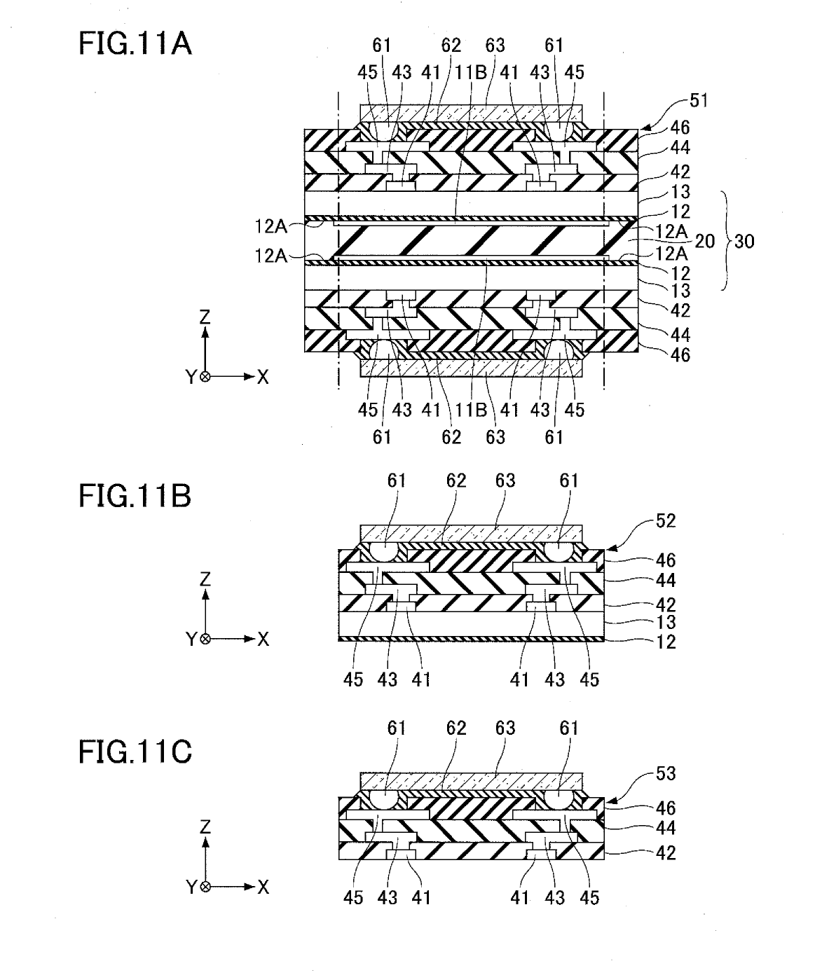

FIGS. 11A-11C are schematic diagrams illustrating steps included in the wiring substrate manufacturing method according to another modified example of the first embodiment of the present invention. The steps illustrated in FIGS. 11A-11C are modified examples of the steps illustrated in FIG. 5B.

As illustrated in FIG. 11A, the bumps 61 may be connected to the wiring layers 45 on both sides of the structural body 51 and a pair of semiconductor chips 63 may be flip-chip mounted on the structural body 51 by using the underfill resin 62 before the adhering part between the outer edge part 12A and the prepreg 20 (i.e. part positioned more outward than the dash-dot line of FIG. 11A) is cut off from the structural body 51.

Then, as illustrated in FIG. 11B, the structural body 51 is separated into pieces by separating the prepreg 20 and the metal foil 11. Thereby, the structural body 52 having the semiconductor chip 63 flip-chip mounted thereon can be obtained. Further, as illustrated in FIG. 11C, the built-up substrate 53 having the semiconductor chip 63 mounted thereon can be obtained by removing the peeling layer 12 and the metal foil 13.

Although the pads 41 are formed directly on the metal foil 13 in the above-described embodiment (see, for example, FIGS. 3A-3C), the pads 41 may be formed on the metal foil 13 interposed by a sacrificial layer.

The sacrificial layer may be formed before the pads 41 are formed by using an electroplating method where the metal foil 13 is used as a power feeding layer. For example, in a case where the pads 41 are formed of copper (Cu), the sacrificial layer may be made of nickel (Ni) and formed on the metal foil 13. The sacrificial layer may be made of copper (Cu) and formed on the metal foil 13 in a case where the pad 41 has a four layer structure having a gold (Ag) layer, a palladium (Pd) layer, a nickel (Ni) layer, and a copper (Cu) layer layered in this order from the side toward the metal foil 13. The sacrificial layer may be formed by using an electroplating layer where the metal foil 13 is used as a power feeding layer.

The sacrificial layer may be removed by using, for example, a wet etching method after the peeling layer 12 and the metal foil 13 are removed.

By forming and removing the sacrificial layer as described above, the surface of the pad 41 can be offset from the surface of the insulating layer 42 of the pad 41.

As illustrated in FIGS. 1A-1C, although the edge part 11A of the metal foil 11 is removed along four sides of the metal foil 11 in the above-described embodiment, the edge part 11A may be removed with respect to a pair of opposing sides of the metal foil 11A (e.g., a pair of sides of the metal foil 11 in the X direction, a pair of sides of the metal foil 11 in the Y direction) instead of removing the edge part 11A on all four sides of the metal foil 11A.

In this case, only both edges in the X direction of the structural body 51 or both edges in the Y direction of the structural body 51 are cut off in the step illustrated in FIG. 5B.

### Second Embodiment

The wiring substrate manufacturing method according to the second embodiment of the present invention is different from the wiring substrate manufacturing method according to the first embodiment of the present invention in that an edge part 12B of the peeling layer 12 is removed in addition to the removal of the edge part 11A of the metal foil 11A, and that the prepreg 20 is adhered to the metal foil 13.

In the second embodiment, like components are denoted by like reference numerals as those of the first embodiment and are not further explained.

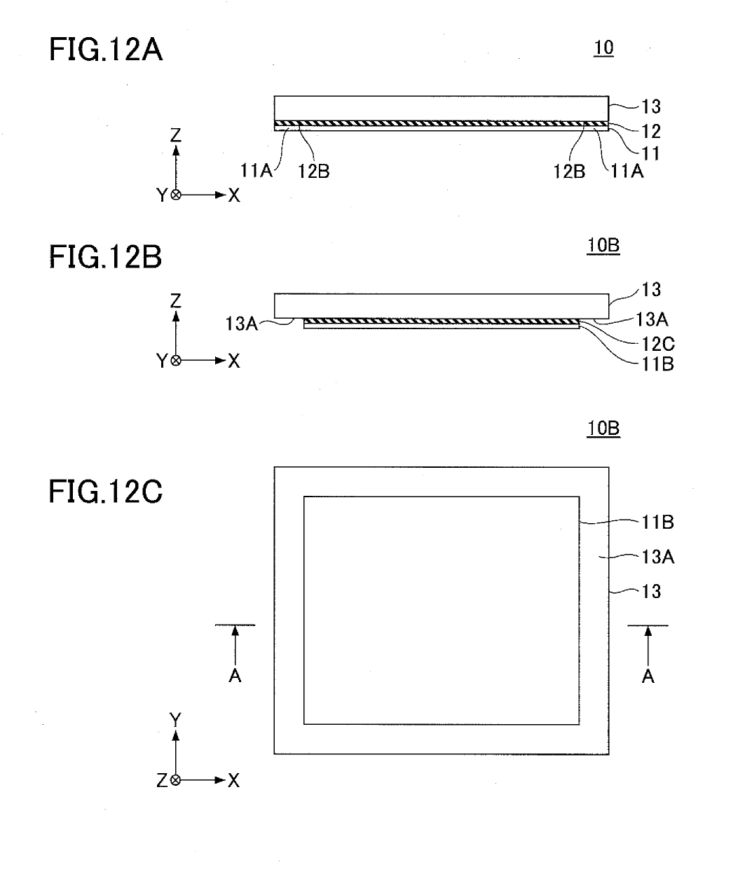

FIGS. 12A-12C are schematic diagrams illustrating steps for processing a layered body by using a method for manufacturing a wiring substrate (wiring substrate manufacturing method) according to the second embodiment of the present invention. The XYZ coordinates are defined as illustrated in FIGS. 12A-12C.

FIGS. 12A-12C correspond to the FIGS. 1A-1C of the first embodiment.

With the wiring substrate manufacturing method according to the second embodiment, a layered body 10 having a cross-section illustrated in FIG. 12A is prepared. The layered body 10 has a layered structure including a metal foil 11, a peeling layer 12, and a metal foil 13 that are layered in this order.

After preparing the layered body 10 illustrated in FIG. 12A, the edge part 11A of the metal foil 11 and the edge part 12B of the peeling layer 12 of the layered body 10 of FIG. 12A are removed along the four sides of the metal foil 11 and the peeling layer 12, respectively. The step of removing the edge parts 11A, 12B is an example of a first step. The edge part 11A is a part of the metal foil 11 having a predetermined width with respect to each of the four sides of the metal foil 11. Likewise, the edge part 12B is a part of the peeling layer 12 having a predetermined width with respect to each of the four sides of the peeling layer 12. That is, the edge parts 11A, 12B are rectangular annular shaped parts formed throughout the outer peripheries of the metal foil 11 and the peeling layer 12, respectively.

As a result of removing the edge parts 11A, 12B, the layered body 10 illustrated in FIG. 12A becomes a layered body 10B illustrated in FIGS. 12B and 12C. That is, as illustrated in FIGS. 12B and 12C, the metal foil 11 and the peeling layer 12 of the layered body 10 of FIG. 1A are processed to become a metal foil 11B and a peeling layer 12C having a smaller outer periphery than the outer periphery of the metal foil 13 from a plan view, respectively. The metal foil 11B and the peeling layer 12C of FIGS. 12B and 12C are remaining parts of the metal foil 11 and the peeling layer 12 of FIG. 12A from which the edge parts 11A, 12B are removed.

A part of the metal foil 13, which is positioned more outward than the metal foil 11B and the peeling layer 12C from a plan view, is hereinafter referred to as an outer edge part 13A of the metal foil 13. As illustrated in FIG. 12C, the outer edge part 13A has a predetermined width with respect to each of the four sides of the metal foil 13. That is, the outer edge part 13A is part of the metal foil 13 that becomes exposed by removing the edge parts 11A, 12B from the metal foil 11 and the peeling layer 12 of FIG. 12A. The outer edge part 13A is an example of a process part of the layered body 10B.

The removing of the edge parts 11A, 12B may be performed by, for example, forming a cut line between a border between the edge part 11A and the metal foil 11B and a border between the edge part 12B and the peeling layer 12C by using a die, and peeling the edge parts 11R, 12B from the metal foil 11 and the peeling layer 12, respectively. Alternatively, the removing of the edge parts 11A, 12B may be performed by forming a cut line between a border between the edge part 11A and the metal foil 11B and a border between the edge part 12B and the peeling layer 12C by using a laser (half cut), and peeling the edge parts 11A, 12B from the metal foil 11 and the peeling layer 12, respectively. Alternatively, the removing of the edge parts 11A, 12B may be performed by forming a mask on the surface of the metal foil 11B and removing the edge parts 11A, 12B from the metal foil 11 and the peeling layer 12 by wet etching. Other methods besides those described above may also be used for removing the edge parts 11A, 12B.

Next, the steps for manufacturing a support body 30B for manufacturing a wiring substrate according to an embodiment of the present invention is described with reference to FIGS. 13A-13B. In this embodiment, the support body 30B is manufactured by adhering the layered body 10B to prepreg 20.

FIGS. 13A-13B are schematic diagrams illustrating the steps for manufacturing a support body 30B with the wiring substrate manufacturing method according to the second embodiment of the present invention. The XYZ coordinates used in FIGS. 12A-12C apply to the XYZ coordinates of FIGS. 13A-13B. FIGS. 13A and 13B are cross-sectional views illustrating a part of the steps for manufacturing the support body 30B. FIGS. 13A and 13B correspond to FIGS. 2A and 2B of the first embodiment.

First, as illustrated in FIG. 13A, two layered bodies 10B and the prepreg 20 are prepared. The positions of the two layered bodies 10B and the prepreg 20 are to be matched among each other. That is, the metal foil 11B of the layered body 10B on the upper side (i.e. the side toward the positive side of the Z axis direction) of the prepreg 20 is facing downward, and the position of the metal foil 13 of the layered body 10B is matched with the position of the prepreg 20. Likewise, the metal foil 11B of the layered body 10B on the lower side (i.e. the side toward the negative side of the Z axis direction) of the prepreg 20 is facing upward, and the positions of the metal foil 13 is matched with the position of the prepreg 20.

Then, the prepreg 20 is cured by applying heat and pressure to the prepreg 20 in a state where the prepreg 20 is sandwiched between the two layered bodies 10B. Thereby, the two layered bodies 102 are respectively adhered to the upper and lower sides of the prepreg 20. In this embodiment, a vacuum laminator is used to cure the prepreg 20. This step of curing the prepreg 20 is an example of a second step.

In adhering each of the layered bodies 10B to the prepreg 20 as illustrated in FIG. 13B, the metal foil 11B and the prepreg 20 are adhered to each other at a center part of the layered body 10B from a plan view. The outer edge part 13A of the metal foil is adhered to a portion of the prepreg 20 that is located further outward than the metal foil 11B from a plan view. The areas indicated with broken lines in FIG. 13B correspond to the areas at which the outer edge part 13A and the portion of the prepreg 20 are adhered to each other.

By adhering the two layered bodies 10B to the prepreg 20 together, the manufacturing of the support body 302 is completed as illustrated in FIGS. 13B and 13C. Thus, the support body 30B is a member that has two layered bodies 10B adhered to the upper and lower sides of the prepreg 20, respectively. The support body 30B has rigidity that is strong enough to support the built-up substrate 53 during the subsequent steps of forming the built-up substrate 53 on the metal foil 13 of the layered body 10B.

The support body 30B of the second embodiment has the metal foil 11B and the outer edge part 13A of the metal foil 13 adhered to the prepreg 20. The adhesive strength between metal foil 11B and the prepreg 20 is greater than the adhesive strength between the metal foil 11B and the peeling layer 12C.

In this embodiment, the adhesive strength between the metal foil 11B and the peeling layer 12C is set to be significantly weak compared to the adhesive strength between the metal foil 11B and the prepreg 20 because the metal foil 11B is to be peeled from the peeling layer 12C in a subsequent step.

Therefore, in the state illustrated in FIG. 13B, the layered body 10B and the prepreg 20 are adhered mainly by the adhesive strength between the outer edge part 13A and the prepreg 20.

After the manufacturing of the support body 30B is completed, the built-up substrate 53 of FIG. 6 can be manufactured by performing the steps described with FIGS. 3A-5D of the first embodiment.

Similar to the first embodiment, the wiring substrate manufacturing method according to the second embodiment can manufacture the built-up substrate 53 at a lower cost and with manufacturing steps having higher reliability compared to those of the conventional wiring substrate manufacturing method. Further, compared to a conventional wiring substrate manufacturing method, the built-up substrate 53 can be manufactured more easily because there are less factors pertaining to the setting of the adhesive strength of the peeling layer 12 (12C).

Although the adhesive strength between the metal foil 11 and the peeling layer 12 is less than the adhesive strength between the metal foil 13 and the peeling layer 12 in the above-described embodiment, the adhesive strength between the metal foil 13 and the peeling layer 12 may be set to be less than the adhesive strength between the metal foil 11 and the peeling layer 12.

In this case, after the built-up substrate 53 is formed, the metal foil 13 and the peeling layer 12 may be separated from each other in the step illustrated in FIG. 5D, so that two structural bodies are obtained, in which one structural body includes the prepreg 20, two metal foils 11B, and two peeling layers 12, and the other structural body includes two structural body parts (each structural body part including the metal foil 13, the pads 41, the insulating layer 42, the wiring layer 43, the insulating layer 44, the wiring layer 45, and the solder resist layer 46).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for manufacturing a wiring substrate, the method comprising:
forming a layered configuration including a first metal layer, a peeling layer, and a second metal layer;
removing an edge part of the layered configuration, so that the first metal layer is smaller than the second metal layer from a plan view;
forming a support body by adhering the first metal layer to a base member and adhering the base member to a process part, the process part being formed by the removing of the edge part of the layered configuration;
forming a wiring substrate on the second metal layer;
removing a part of the support body and a part of the wiring substrate that are superposed with respect to the process part from a plan view;
separating the second metal layer and the wiring substrate from the support body after the removing of the part of the support body and the part of the wiring substrate.

2. The method as claimed in claim 1,
wherein the edge part of the layered configuration includes a part of the first metal layer that is formed throughout an outer periphery of the first metal layer,
wherein the process part includes an outer periphery of the peeling layer.

3. The method as claimed in claim 1,
wherein the edge part of the layered configuration includes a part of the first metal layer that is formed throughout an outer periphery of the first metal layer and a part of the peeling layer that is formed throughout an outer periphery of the peeling layer,
wherein the process part includes an outer periphery of the second metal layer.

4. The method as claimed in claim 1,
wherein the base member has an adhesive property,
wherein the adhering of the first metal layer and the base member and the adhering of the base member and the process part includes applying heat and pressure to the layered configuration and the base member.

5. The method as claimed in claim 1, wherein the removing of the part of the support body and the part of the wiring substrate includes removing a part of the support body and a part of the wiring substrate that are positioned a predetermined length inward with respect to the part of the support body and the part of the wiring substrate that are superposed with respect to the process part from a plan view.

6. The method as claimed in claim 1, wherein the separating of the second metal layer and the wiring substrate includes peeling the peeling layer and the first metal layer from each other and separating the peeling layer, the second metal layer, and the wiring layer from the support body.

7. The method as claimed in claim 1, wherein the separating of the second metal layer and the wiring substrate includes peeling the peeling layer and the second metal layer from each other and separating the second metal layer and the wiring layer from the support body.

8. The method as claimed in claim 1, wherein the wiring substrate and the second metal layer are separated from each other after the second metal layer and the wiring substrate are separated from the support body.

9. The method as claimed in claim 1, wherein the base member includes a prepreg.

10. The method as claimed in claim 1,
wherein the layered configuration is formed on both sides of the base member,
wherein the wiring substrate is formed on the layered configuration formed on the both sides of the base member.

11. The method as claimed in claim 1, further comprising: forming another base member on the base member.

12. A support body for manufacturing a wiring substrate, the support body comprising:
a base member;
a first metal layer formed on the base member;
a peeling layer formed on the first metal layer;
a second metal layer formed on the peeling layer;
wherein the first metal layer includes an edge part,
wherein the second metal layer includes an edge part,
wherein the edge part of the first metal layer is positioned more inward than the edge part of the second metal layer from a plan view.

13. The support body as claimed in claim 12,
wherein the peeling layer includes an edge part,
wherein the edge part of the first metal layer is positioned more inward than the edge part of the peeling layer,
wherein an outer peripheral part of the peeling layer is adhered to a surface of the base member.

14. The support body as claimed in claim 12,
wherein the peeling layer includes an edge part,
wherein the edge part of the first metal layer and the edge part of the peeling layer are positioned more inward than the edge part of the second metal layer,
wherein an outer peripheral part of the first metal layer is adhered to a surface of the base member.

15. The support body as claimed in claim 13,
wherein the first metal layer includes a first surface and an edge surface that are adhered to the base member, and a second surface contacting the peeling layer,
wherein the first metal layer is buried in a surface of the base member.

16. The support body as claimed in claim 12, wherein an adhesive strength between the peeling layer and the second metal layer is greater than an adhesive strength between the peeling layer and the first metal layer.

17. The support body as claimed in claim 12, wherein an adhesive strength between the peeling layer and the first metal layer is greater than an adhesive strength between the peeling layer and the second metal layer.

18. The support body as claimed in claim 12,
wherein the base member includes a front surface and a back surface,
wherein the first metal layer, the peeling layer, and the second metal layer are layered on both the front and the back surfaces of the base member.

19. The support body as claimed in claim 12, wherein the first and the second metal layers are metal foils.

20. The support body as claimed in claim 12, wherein the peeling layer includes a metal layer, an inorganic material layer, or a resin layer formed of an organic material.
